(19) United States
(12) Patent Application Publication
(10) Pub. No.: US 2022/0106183 A1
(43) Pub. Date: Apr. 7, 2022

(54) INLET FOR TRANSFERRING PROPPANT

(71) Applicant: Hi-Crush Canada Inc., Houston, TX (US)

(72) Inventors: Roy Richmond, Cypress, TX (US); William Wood, Hobbs, NM (US); Gustavo Alvarez, Azle, TX (US)

(21) Appl. No.: 17/063,467

(22) Filed: Oct. 5, 2020

(51) Int. Cl. B67D 7/02; B67D 7/30; B67D 7/78

(52) U.S. Cl. CPC B67D 7/0288; B65D 88/548; B67D 7/78; B67D 7/30

(57) ABSTRACT

An apparatus, system, and method for receiving proppant into a storage container is disclosed. In certain embodiments, an apparatus for receiving proppant into a storage container may comprise a housing that further comprises a first planar surface having an outlet port and a second planar surface substantially perpendicular to the first planar surface, the second planar surface having a tubular slot formed therein. In certain embodiments, the apparatus comprises a diverter plate coupled to the housing and adjacent the outlet port, the diverter plate being oriented at an acute angle to the first planar surface of the housing.

### TECHNICAL FIELD

This invention relates to an apparatus and system for pneumatically transporting proppant to a storage container.

### BACKGROUND

Large quantities of proppant are often transported to and stored at a well site to support fracturing operations. Current methods of transporting proppant to a wellsite typically include the use of large transport vehicles, for example, trucks or trailers, carrying proppant to pneumatically pump proppant from the truck or trailer into the inlet of a top-filled or near-top-filled storage container, such as a silo. Significant pneumatic pressure is required to efficiently pump large amounts of proppant from a truck or trailer to the inlet of a silo, which may be positioned at a vertical height of 30 to 50 feet above the truck or trailer.

Current inlets for proppant storage containers create resistance due to the shape and angle of the inlets. For example, current inlets require proppant being pumped in a vertical direction through the piping of the silo to change directions through multiple points of impact in order to reach the opening of the silo, sometimes at an angle of 90 degrees or more. As a result of this sharp directional change, proppant moving through an inlet and into a silo lose velocity, thereby decreasing the overall flow of proppant. Other types of inlets with different geometries or shapes may have similar issues of multiple wear points created along the course of the inlet due to abrasion and multiple impact points. The adverse effect on proppant flow is compounded by adverse effects on proppant unloading operations, which can lead to other downstream consequences. This leads to inefficiencies at the well site as valuable equipment and real estate resources are wasted.

### SUMMARY

In accordance with the above, presently disclosed embodiments are directed to an apparatus and system for unloading proppant into a storage container.

In certain embodiments, an apparatus for receiving proppant into a storage container may comprise a housing that further comprises a first planar surface having an outlet port and a second planar surface substantially perpendicular to the first planar surface, the second planar surface having a tubular slot formed therein. In certain embodiments, the apparatus comprises a diverter plate coupled to the housing and adjacent the outlet port, the diverter plate being oriented at an acute angle to the first planar surface of the housing.

In certain embodiments, the diverter plate may be removable from the housing. In certain embodiments, the housing may be coupled to a fill tube via the tubular slot. In certain embodiments, the outlet port of the inlet may be coupled to a filler opening of the storage container. In certain embodiments, the diverter plate may comprise a material thickness that is thicker than a material thickness of the housing. In certain embodiments, the apparatus may comprise a single impact point. In certain embodiments, the diverter plate may be oriented at an angle of 45 degrees from the first planar surface of the housing.

In certain embodiments, a system for transferring proppant may comprise a storage container for storing proppant, wherein the storage container comprises a filler opening at or adjacent to a top of the storage container, and an inlet apparatus, wherein the inlet apparatus is coupled to the storage container. In certain embodiments, the inlet apparatus comprises a housing that further comprises a first planar surface having an outlet port, wherein the outlet port is coupled to the filler opening of the storage container, and a second planar surface substantially perpendicular to the first planar surface, the second planar surface having a tubular slot formed therein, and a diverter plate coupled to the housing and adjacent the outlet port, the diverter plate being oriented at an acute angle to the first planar surface of the housing.

In certain embodiments, the storage container is a silo. In certain embodiments, a fill tube may be coupled to and positioned vertically along the silo, wherein the fill tube may be coupled to the inlet apparatus via the tubular slot. In certain embodiments, the fill tube may be coupled to the inlet apparatus via one or more fasteners such that a seal is formed between the fill tube and the inlet apparatus. In certain embodiments, the fill tube may be coupled to a transport vehicle via one or more flexible hoses. In certain embodiments, the diverter plate may be removable from the housing. In certain embodiments, a first inlet apparatus and a second inlet apparatus are both coupled to the storage container.

In certain embodiments, a method for receiving proppant into a silo comprises coupling an inlet apparatus to a filler opening at or adjacent to a top of the silo, wherein the inlet apparatus comprises a housing. In certain embodiments, the housing comprises a first planar surface having an outlet port and a second planar surface substantially perpendicular to the first planar surface, the second planar surface having a tubular slot formed therein. In certain embodiments, the inlet apparatus comprises a diverter plate coupled to the housing and adjacent the outlet port, the diverter plate being oriented at an acute angle to the first planar surface of the housing. In certain embodiments, the method for receiving proppant into a silo comprises coupling the inlet to a fill tube positioned along the silo, wherein the fill tube is further coupled to a transport vehicle for unloading proppant, and pneumatically pumping proppant from the transport vehicle through the inlet apparatus and into the silo.

In certain embodiments, the method for receiving proppant into a silo further comprises removing the diverter plate from the inlet apparatus and coupling a new diverter plate to the inlet apparatus. In certain embodiments, coupling the inlet apparatus to the filler opening of the silo comprises welding the inlet apparatus to the silo. In certain embodiments, coupling the inlet apparatus to the fill tube comprises securing the inlet apparatus to the fill tube using one or more fasteners. In certain embodiments, the method for receiving proppant into a silo further comprises discharging proppant from the silo onto a conveyor and transporting proppant to a blender or mixer. In certain embodiments, the method for receiving proppant into a silo further comprises detecting a measured amount of proppant stored in the silo, comparing the measured amount of proppant to a threshold, and if the measured amount of proppant is less than the threshold, pneumatically pumping additional proppant from the transport vehicle through the inlet apparatus and into the silo.

### BRIEF DESCRIPTION OF THE DRAWINGS

For a more complete understanding of the present disclosure and its features and advantages, reference is now made to the following description, taken in conjunction with the accompanying drawings, in which:

FIG. 1A depicts an inlet, in accordance with prior methods and systems.

FIG. 1B depicts an inlet coupled to a storage container, in accordance with prior methods and systems.

FIG. 2A depicts an inlet, in accordance with prior methods and systems.

FIG. 2B depicts an inlet coupled to a storage container, in accordance with prior methods and systems.

FIG. 3A depicts a silo inlet, in accordance with aspects of the present disclosure.

FIG. 3B depicts a front view of a silo inlet, in accordance with certain aspects of the present disclosure.

FIG. 3C depicts side view of a silo inlet, in accordance with certain aspects of the present disclosure.

FIG. 3D depicts a rear view of a silo inlet, in accordance with certain aspects of the present disclosure.

FIG. 4A depicts a top portion of a silo with filler openings, in accordance with certain aspects of the present disclosure.

FIG. 4B depicts an inlet coupled to a silo, in accordance with certain aspects of the present disclosure.

FIG. 5 depicts a well site with one or more inlets mounted on one or more silos, in accordance with aspects of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation-specific decisions must be made to achieve the developers' specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of the present disclosure. Furthermore, in no way should the following examples be read to limit, or define, the scope of the disclosure.

In hydraulic fracturing operations, a wellbore may be formed in a subterranean formation that extends below the surface. The wellbore may be drilled in a horizontal, vertical, slanted, curved, or any other direction. The wellbore may be cemented and may include a casing. In some embodiments, a perforator may be disposed in the wellbore for creating perforations in the wellbore to allow fracturing fluids to flow into the subterranean formation. Furthermore, typical well stimulation jobs may include using different well treatment fluids. Well treatment fluids called fracturing fluids are commonly used in hydraulic fracturing operations. These fracturing fluids are introduced into a wellbore at pressures sufficient to create or enhance one or more fractures within a subterranean formation. These fracturing fluids may be pumped downhole with sufficient hydraulic pressure to create fractures or microfractures in a subterranean formation. Furthermore, the fracturing fluids may include suspended solid particulate called proppant. Proppant may be placed in the created or enhanced fractures and used to hold or prop open the fractures once the pressure is reduced and the well is placed into production. Thus, having an appropriate amount of proppant available at a wellsite is essential for hydraulic fracturing operations.

As used herein, “proppant” may generally refer to sand, salt, dirt, grain, fertilizer, aggregate, or any other particulate material or solid additive (or combination of such materials) that may be used in fracturing operations to hold or prop open fractures created by hydraulic fracturing. “Proppant” as described herein may refer to naturally occurring particulate materials and/or particles that are coated with a material, such as resin, and manmade products, such as ceramics. As would be understood by one of ordinary skill in the art, other types of elements or particulates may be substituted without changing the scope of the present disclosure.

Proppant may be loaded into a dump truck or other transport vehicle and delivered via the truck to another location for storage. The storage location may comprise, for example, a barge, ship, rail car, trailer, bin, silo, or indoor bulk storage facility. The arrangement shown herein may be particularly, but not exclusively suited for transferring the particulate material into containment structures at a height above the ground, for example, silos. Proppant or other particulate materials may be suited for stacking in a stockpile for storage for later use. Trucks or trailers may provide relatively flexible transportation of proppant from one location to another. For example, trucks and trailers may navigate both paved and unpaved roadways. Thus, trucks and trailers may be used to transport proppant to a desired destination, for example, a well site, despite difficult terrain.

Storage space as a wellsite is often limited due to lack of real estate and the amount of equipment and personnel needed for such operations. For example, at some well sites, the presence of drilling and production equipment limits the amount of space available for large transport trucks. Well sites are often lacking ample real estate for trucks to unload and for multiple trucks to enter and exit simultaneously. Thus, once at a well site, it is beneficial to unload the proppant from trucks or trailers into storage containers as efficiently as possible to allow the trucks to stay on schedule.

Silos or other storage containers at a well site or job site may have a filling opening at or adjacent to the top of the tank and a discharge opening at or adjacent at the bottom of the tank. A transport vehicle unloading particulate at a well site into a silo may pneumatically pump the proppant vertically upwards to the filling opening by connecting to vertical piping or tubing. In certain embodiments, a truck or trailer may be connected to a flexible hosing which is then connected to the vertical fill piping or tubing coupled to the silo. The fill piping or tubing may be used to transport proppant to an inlet that facilitates the transfer of proppant between the truck and the silo. The inlet is a crucial component of the proppant unloading process to quickly and efficiently fill the silos or storage containers, while also limiting the amount of dust emanating as a result of the transfer of proppant. An inlet also may limit damage to the proppant being transferred, especially be decreasing the number of impact or wear points used in prior inlets.

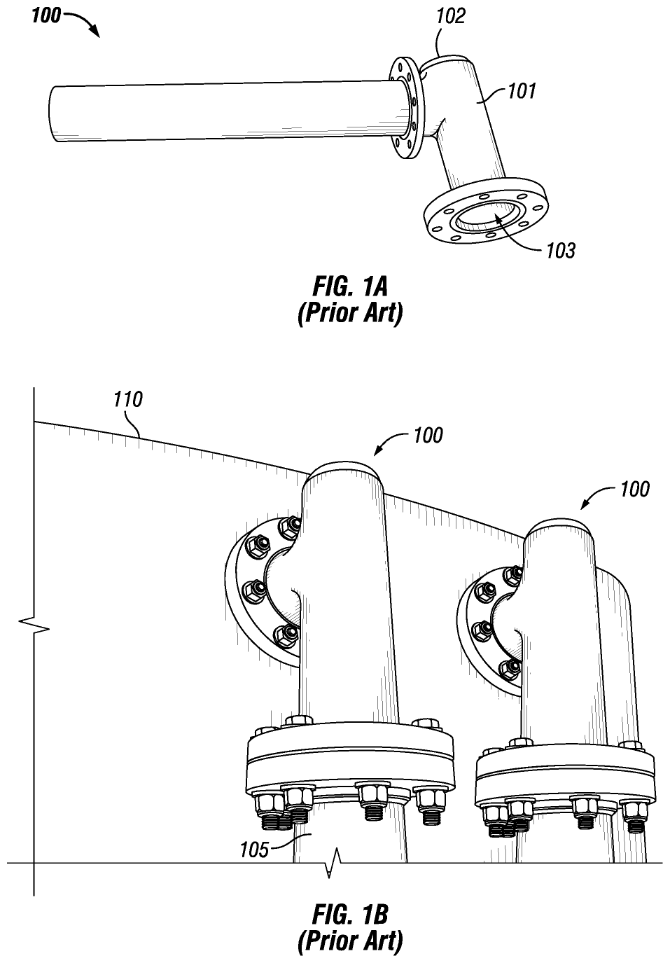

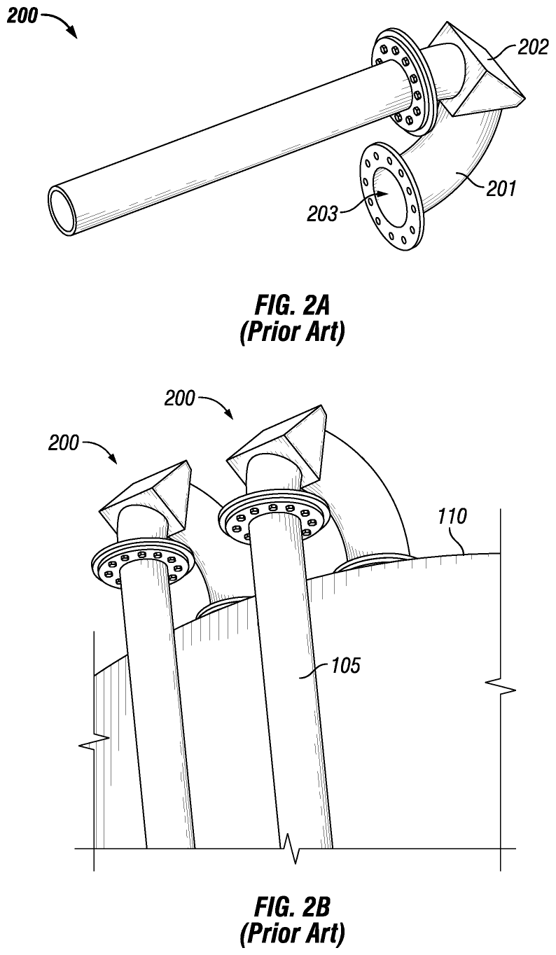

One type of inlet used in prior methods and systems for facilitating the unloading of proppant into a storage container is depicted in FIGS. 1A and 1B. Such an inlet may be commonly referred to as a “blind-T” inlet. Blind-T inlets, for example the blind-T inlet 100 depicted in FIGS. 1A and 1B, may comprise a perpendicular or substantially perpendicular directional turn at a joint 101. Blind-T inlet may also comprise a blanked portion 102 that functions as an end stop for the particulate traveling up the fill tube 105, as depicted in FIG. 1B. One issue common to a blind-T inlet 100 is that over time, proppant may accumulate, clog, or otherwise get backed up in the joint portion 101 of the blind-T inlet 100. This is primarily due to the sharp angle and/or the “hard stop” of the blind-T inlet 100 at the joint 101, where the proppant must come to a stop or near-stop before the proppant must make a 90-degree angle turn towards the opening 103 of the blind-T inlet 100. The slowed or stopped momentum of the proppant traveling through a blind-T inlet 100 causes inefficient unloading or proppant.

As a result of the build-up of proppant in the blind-T inlet 100, the available surface area through which proppant may flow to reach opening 103 is decreased, thus decreasing flow of proppant or in some cases stopping flow completely. This may lead to direct adverse effects, for example, delays in unloading of trucks or trailers transporting the proppant. Delays in unloading may further cause other downstream delays as other transport trucks or trailers may be waiting to unload particulate, taking up valuable real estate for other equipment or personnel at a well site. Additionally, the longer unloading process caused by the blind-T inlet 100 leads to the longer use of energy resources, which may reduce the amount of valuable energy resources for other well site operations. For example, increased truck unloading time may result in decreased truck efficiency, increasing costs associated with truck drivers, equipment costs, etc.

Another apparatus for facilitating the transport of proppant into a storage container is a shepherd's hook inlet, for example, the shepherd's hook inlet 200 depicted in FIGS. 2A and 2B. Rather than a 90-degree turn as with the blind-T inlet 100, a shepherd's hook inlet provides a curved portion 201 that creates a substantially 180-degree turn. In certain embodiments, a shepherd's hook inlet 200 may further comprise a joint connector 202 that couples to the curved portion 201 to facilitate the 180-degree turn. However, certain embodiments of a shepherd's hook inlet 200 may not comprise a joint connector 202. In certain embodiments, curved portion 201 may be shaped or configured such that the opening 203 of shepherd's hook inlet 200 is on the top of silo 110 as shown in FIG. 2B, rather than on the side of silo 110 as with the blind-T inlet 100.

A shepherd's hook inlet 200 attempts to address the aforementioned problems with the blind-T inlet 100 by eliminating the “hard stop” of the 90-degree turn required by the blind-T inlet. However, proppant flow through the shepherd's hook inlet 200 may still decrease due to the directional change and multiple impact points of the curved portion 201, joint portion 202, or both, required by the shepherd's hook inlet 200. As shown by FIGS. 2A and 2B, the shepherd's hook inlet 200 requires a complete reversal in direction of proppant. That is, proppant traveling vertically upwards through the fill tube 105 must complete a 180 degree directional turn through the shepherd's hook inlet 200, and enter the top of the silo 110 vertically downwards. Thus, the shepherd's hook inlet 200 completely stops the momentum of the proppant, resulting in decreased proppant velocity and therefore, inefficient proppant unloading time. Consequently, the same downstream inefficiencies may result as discussed above with the blind-T inlet 100. Additionally, the multiple wear points of the shepherd's hook inlet 200 may ultimately decrease the length of its useful life, causing the shepherd's hook inlet 200 to be replaced more frequently and increasing equipment and personnel costs.

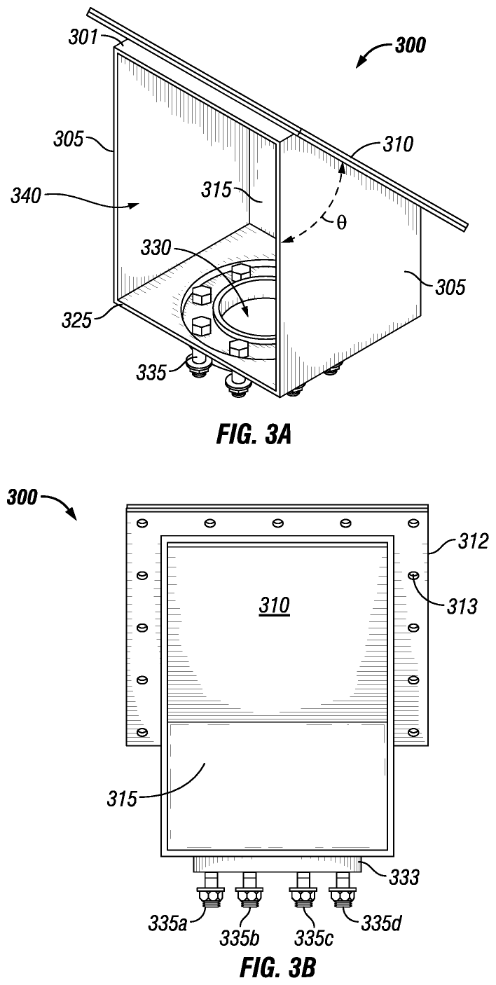

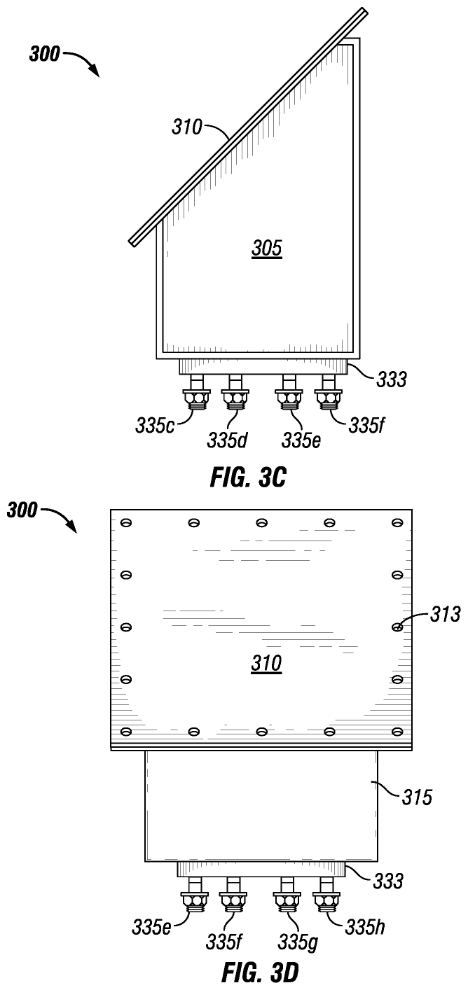

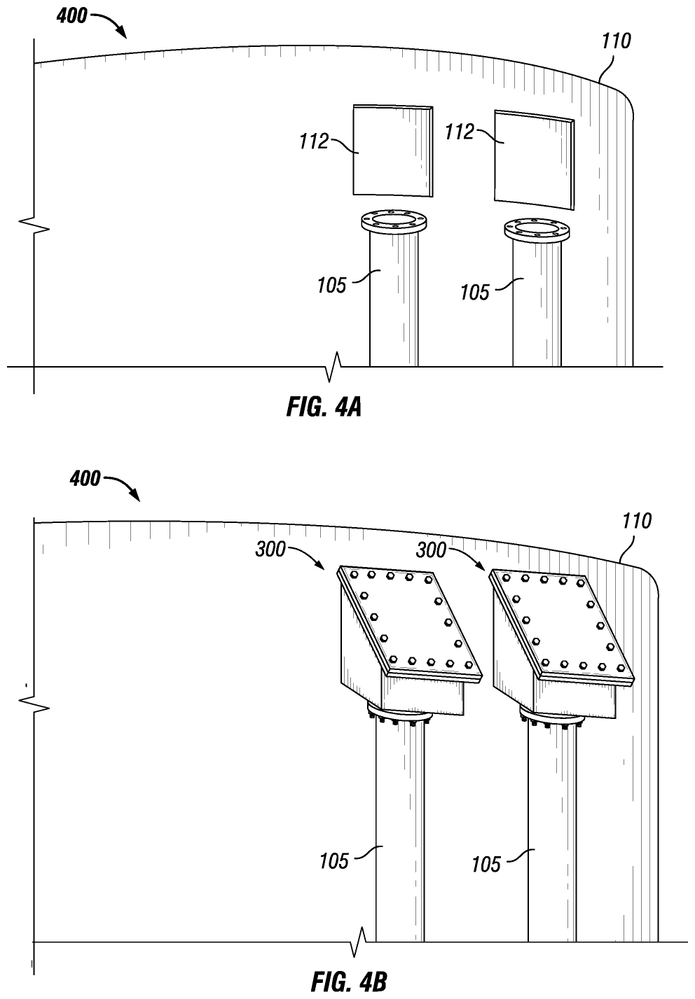

FIGS. 3A-3D depict an inlet apparatus, box inlet 300, in accordance with certain aspects of the present disclosure. Box inlet 300 may comprise steel, galvanized steel, aluminum, iron, or any other type of suitable metal, as would be understood by one of ordinary skill in the art. In certain embodiments, box inlet 300 may have a material thickness of 0.5 inches. In other embodiments, box inlet 300 may have a material thickness of 0.25 inches, 0.75 inches, 1 inch, or any other suitable thickness. As would be understood by one of ordinary skill in the art, the material thickness of box inlet 300 may be selected or varied based on one or more factors, for example, the thickness of the material of the vertical pipe or fill tube 105 (shown in FIG. 4). In general, the fill tube 105 will not experience as much wear as the inlet portion, and thus, the material of the box inlet 300 may be selected such that it is equal to or thicker than the fill tube 105.

Referring now to FIG. 3A, in certain embodiments, box inlet 300 may comprise a generally trapezoidal shape. Box inlet 300 may comprise a housing 301 and a diverter plate 310. In certain embodiments, box inlet 300 may further comprise a rear panel 315, side panels 305, and a bottom panel 325, each oriented along planar surfaces. Bottom panel 325 may further comprise a tube slot or tubular slot 330. Housing 301 may comprise an opening or outlet port 340. In certain embodiments, the dimensions of housing 301 may be selected to create a slight pressure drop between the fill tube 105 and the housing 301 of box inlet 300, but the pressure difference should not be so much as to result in a loss in velocity of the transferred proppant.

In certain embodiments, diverter plate 310 may be positioned at an angle θ from vertical or from the planar surface of the outlet port 340. For example, in certain embodiments, angle θ may be a 45-degree angle. In other embodiments, diverter plate may be positioned at another angle θ, for example, 15 degrees, 30 degrees, 60 degrees, or 75 degrees from vertical or from the planar surface of the outlet port 340, in keeping with aspects of the present disclosure. In certain embodiments, diverter plate 310 may be angled at any angle θ in a range, for example, 30-60 degrees from vertical or from the planar surface of the outlet port 340. In certain embodiments, diverter plate 310 may be oriented at any acute angle θ from vertical or from the planar surface of the outlet port 340. The diverter plate 310 may be angled in relation to the outlet port 340 such that proppant contacting the diverter plate 310 is redirected through the outlet port 340. As would be understood by one of ordinary skill, the optimum angle may be determined based on one or more factors, for example, the dimensions of the housing 301, size of the tubular slot 330, rate of flow of proppant, or any other number of factors.

Bottom panel 325 may further comprise one or more fasteners 335, for example, fasteners 335a, 335b, 335c, 335d, 335e, 335f, 335g, and 335h, as shown more clearly in FIGS. 3B-3D. In certain embodiments, box inlet 300 may comprise eight fasteners 335, however, as would be understood by one of ordinary skill in the art, any number of fasteners 335 may be appropriate and used with box inlet 300 in keeping with aspects of the present disclosure. Fastener 335 may comprise a screw, bolt, nut, or other type of connector, and any combination thereof, for coupling the inlet 300 to the fill tube 105. For example, in certain embodiments, fastener 335 may comprise one or more components, such as a screw and a hex nut, so that no specialty tools are required for installation on or removal from the fill tube 105 of the box inlet 300. As would be understood by one of ordinary skill in the art, fastener 335 should sufficiently secure the inlet 300 to the fill tube 105 to create an effective seal, such that the no proppant is able to escape from fill tube 105 and/or the inlet 300. Additionally, fastener 335 should provide sufficient structural stability to both inlet 300 and fill tube 105.

As shown in FIG. 3A, in certain embodiments, one or more fasteners 335 may be arranged radially about the center of bottom panel 325 and concentrically around the circumference of the tubular slot 330. When installing the inlet 300, tubular slot 330 may be aligned with fill tube 105 and fasteners 335 may be aligned with one or more grooves or holes in the fill tube 105, as shown in FIG. 4A, so that the inlet 300 may be secured and tightened to the fill tube 105. As would be understood by one of ordinary skill in the art, one or more fasteners 335 may be arranged in another configuration so long as the fasteners 335 securely couple the inlet 300 to the fill tube 105. For example, in other embodiments, one or more fasteners may be arranged on the corners of bottom panel 325 (not shown). The diameter of tubular slot 330 may be chosen based on the diameter of fill tube 105. For example, in certain embodiments, tubular slot 330 may have a 5-inch diameter and fill tube 105 may have a 5-inch diameter. As would be understood by one of ordinary skill in the art, other diameters of tube slot 330 may be appropriate, for example, 3 inches, 4 inches, 6 inches, or 7 inches.

As depicted more clearly in FIG. 3B, diverter plate 310 may be similarly coupled or secured to the housing 301. In certain embodiments, diverter plate 310 may be bolted to housing 301 with one or more fasteners 335 such that no specialty tools are required for installation or removal of the diverter plate 310. For example, diverter plate may be bolted to a frame 312, which may comprise one or more holes 313 and one or more fasteners 335 (not shown). Thus, diverter plate 310 may comprise one or more holes 313 that correspond to the holes 313 of the housing 301. As with the fastener 335 for the tube slot 330, fastener 335 may comprise one or more components, for example, a screw, bolt, nut, or any other type of fastener or connector for securely coupling the diverter plate 310 to the housing 301.

Due to the pneumatic pressure from the pumping, proppant is pumped from a truck or trailer up through tubular slot 330 and into the housing 301 of the box inlet 300. The angle and position of the diverter plate 310 deflects the proppant towards and through the opening or outlet port 340. No hard-stop or sharp turn is required, as the diverter plate 310 redirects the particulate towards the opening or outlet port 340 and into the silo 110. Because diverter plate 300 absorbs the brunt of the force from the proppant flow under pneumatic pressure, in certain embodiments, diverter plate 310 may comprise a thicker material than the rest of the housing 301 of box inlet 300. For example, in certain embodiments where housing 301 is 0.5 inches, diverter plate 310 may be 0.75 inches or 1 inch thick. Additionally, in certain embodiments, diverter plate 310 may be replaced more frequently than other components of the box inlet 300. However, due to the modular and removable nature of diverter plate 310, material costs may be saved because only the diverter plate 310 need be replaced for a given box inlet 300, rather than the entire inlet as with prior systems. Diverter plate 310 may be comprised of similar or the same material to the housing 301, for example, steel, galvanized steel, aluminum, iron, or any other type of suitable metal, as would be understood by one of ordinary skill in the art.

One or more box inlets 300 may be coupled to a silo 110 as shown in FIGS. 4A and 4B, in accordance with certain aspects of the present disclosure. FIG. 4A depicts a top portion 400 of a silo 110 with one or more filler openings 112. As shown in FIG. 4A, in certain embodiments, one or more filler openings 112 may be positioned on the side of a silo 110 at, adjacent, or near the top portion 400 of the silo 110. In other embodiments, one or more filler openings 112 may be positioned on top of the silo 110, in addition to or instead of the filler openings positioned on the side of the silo 110 (not shown). As would be understood by one of ordinary skill in the art, the number of filler openings 112 and inlets 300 may be varied based on one or more factors, for example, the desired rate of unloading proppant.

As shown in FIG. 4B, one or more box inlets 300 may be mounted at or near the top portion 400 of silo 110, on top of and coupled to fill tube 105. Box inlet 300 may be coupled to fill tube 105 via one or more fasteners 335, as described above with respect to FIG. 3. Box inlet 300 may be mounted such that the outlet port 340 of box inlet is substantially aligned with the filler opening 112 of silo 110. In certain embodiments, box inlet 300 may be welded or otherwise coupled to the silo 110 forming a seal such that there is no gap or space between the outlet port 340 of inlet 300 and the filler opening 112 of silo 110. In other embodiments, box inlet 300 may be coupled to silo 110 with a fastener 335 or a bolted flange (not shown).

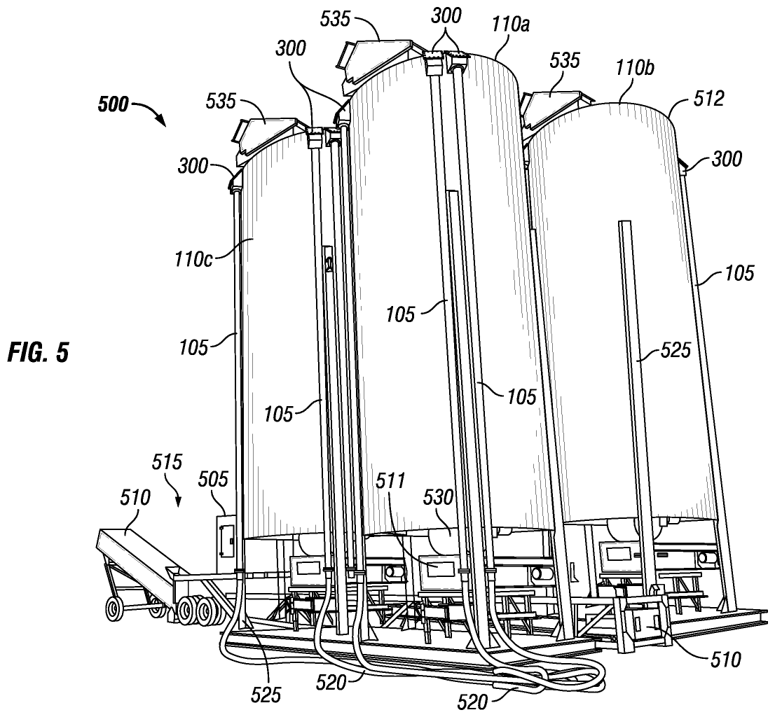

Proppant is pumped pneumatically from a truck or trailer vertically upwards through fill tube 105 and into the box inlet 300, as depicted in FIG. 5. As described previously, proppant that is pumped into a box inlet 300 is deflected by the diverter plate 310 and redirected into the silo 110. The box inlet 300 reduces or eliminates the issues described above with respect the blind-T inlet 100 and the shepherd's hook inlet 200, depicted in FIGS. 1 and 2, respectively. Specifically, as shown in FIG. 4, box inlet 300 requires no sharp-angled turn or hard stop as with the blind-T inlet 100, nor does it require a complete reversal of direction as with the shepherd's hook inlet 200. Rather, box inlet 300 takes advantage of the momentum of the proppant provided by pneumatic pressure to contact the diverter plate 310 and redirect the proppant into an opening or outlet port 340 of the silo 110. Unlike previous systems that comprise inlets with multiple impact points, the box inlet 300 has a single impact point or wear point at the diverter plate 310. Thus, box inlet 300 creates the least amount of resistance, especially compared to prior inlets discussed herein, such that proppant easily flows through the opening or outlet port 340 and into the silo 100.

FIG. 5 depicts a well site 500 in accordance with one or more aspects of the present disclosure. A well site 500 may comprise one or more storage units for storing proppant to be used in fracturing operations, for example, one or more silos 110. Additionally, a well site 500 may include various types of equipment and components to support operations such as hydraulic fracturing operations, drilling operations, or production operations. A well site may include, but is not limited to, equipment such as power sources, piping, tubing, blenders, mixers, valves, pumps, separators, compressors, storage tanks, and other drilling and production equipment (not shown). In some embodiments, some of the aforementioned equipment may be located at another area away from the one or more silos 110. For example, in some embodiments, blenders and/or mixers may be located at a well site 500 for producing the compositions or fluids needed for fracturing operations at a well site 500, and in other embodiments, compositions or fluids may be produced remote from and later delivered to a well site 500.

In certain embodiments, storage units may comprise silos or other types of containers, for example, surge tanks, hoppers, or any other large container suitable for storing proppant or other particulate material. A silo 110 may be portable or fixed to an unloading area 515. A silo 110 may comprise a cylindrical tank 512 for storing proppant with a filler opening (not shown) at the top of the tank 512 and a discharge opening or outlet (not shown) at or adjacent to the bottom of the tank. In certain embodiments, the tank 512 may have a height greater than 30-40 feet. In certain embodiments, the tank 512 may have a diameter less than 13 to 15 feet which, which may allow the tank 512 to be portable on a flat-bed trailer as the maximum allowing road transport. In certain embodiments, a silo 110 may provide capacity to store 100,000 to 1 million pounds of proppant.

Proppant may be stored in a silo 110 until it is deposited into a blender or mixer (not shown) for producing one or more fracturing fluids or compositions. A silo 110 may further comprise one or more sensors (not shown) for measuring the amount of proppant available in a given silo 110. The one or more sensors may measure the amount of proppant to determine a period of well operations, for example, the production of fracturing fluids, a given silo 110 may be able to support. For example, a certain amount of proppant contained in a silo 110 may correspond to a certain period of well operations in minutes, hours, or days. In certain embodiments, silos 110 may further comprise a display or control panel (not shown) for monitoring the amount of proppant in a given silo 110.

A well site 500 may comprise one or more unloading areas 515 for one or more large transport trucks or trailers, for example transport vehicle 505, to unload particulate. An unloading area 515 of a well site 500 may be adjacent to or in close proximity to one or more storage units, for example, silos 110. In some embodiments, the unloading area 515 may be positioned between one or more silos 110, such that one or more silos 110 are on either or both sides of the parked transport vehicle 505. For example, as shown in FIG. 1, a transport vehicle 505 may be parked in an unloading area 515 such that two silos 110 are on either side of the unloading area 515. In other embodiments, the transport vehicle 505 may be positioned in an unloading area 515 such that one or more silos 110 are only on one side of the transport vehicle 505. A transport vehicle 505 may then be coupled to one or more silos 110 via one or more flexible hoses 520 for unloading proppant.

In some embodiments, an unloading area 515 may comprise a portable drive-over conveyor (not shown) for transporting proppant from a transport truck directly to the one or more silos 110. The portable drive-over conveyor may comprise ramp assemblies for allowing one or more transport trucks to drive on top of the portable drive-over conveyor. The portable drive-over conveyor may further comprise a swivel chute to allow one or more silos 110 to be filled from a single location. In some embodiments, the portable drive-over conveyor may comprise a camera at the top of the conveyor to help with aligning the swivel chute over the one or more silos 110.

The unloading area 515 may comprise a pressurized vertical piping, for example fill tube 105, for pumping proppant vertically upwards from a transport vehicle 505 to the top of a silo 110. At or near the top of silo 110, for example, at a top portion 400 as shown in FIG. 4, proppant may be pumped through box inlet 300 and into the silo 110. In certain embodiments, a conveyor (not shown) may be fluidically coupled to a filler opening at the top of one or more silos 110 for direct transfer of proppant from the trucks to the silos 115. For example, proppant that is pumped from a transport truck through the conveyor via pressurized piping may fall or flow directly into one or more silos 110 via filler openings of the one or more silos 110. In these embodiments, a box inlet 300 may be rotated or oriented differently than in FIG. 4 to facilitate the transfer of proppant from conveyor to a top-filled silo 110.

In certain embodiments, a silo 110 may further comprise one or more bin vents 535 on top of the silo 110. Bin vents 535 may comprise pleated filters or socks (not shown) for allowing air to pass through the bin vents 535 and leave the silo 110, while returning particulate matter to the silo 110. Bin vents 535 may effectively discharge excess air pneumatically pumped to the silo 110 from the transport vehicle 505, such that back-pressure through the fill tube 105 and flexible hoses 520 is reduced and allowing for more efficient unloading.

The silo 110 may further comprise a support assembly 525 for holding the tank 512 raised from the ground such that the discharge opening (not shown) is raised for discharge into a receptacle at the ground. The support assembly 525 may include a base for resting on the ground. In some embodiments, silos 110 may be mounted or coupled to one or more trailers (not shown) at an unloading area 515. Transport vehicles 505 at an unloading area 515 may comprise wheels for easy transportation from location to location. Each silo 110 may be associated with a transport vehicle 505, or multiple silos 110 may be associated with a given transport vehicle 505. Other components, such as the conveyor for transporting proppant from the trucks to the silos 110, pressurized piping, and any other required components may also be rigged up to one or more trailers. In some embodiments, all the components of an unloading area 110 may be easily portable.

One or more conveyors 510 may be disposed near or adjacent to a silo 110 such for transporting proppant discharged from the silo 110 to another location. In certain embodiments, the discharge opening is coupled to a metering device 530 positioned underneath the silo 110. The metering device 530 may control the speed at which proppant is discharged from silo 110 and onto a transport or conveyor below the metering device 530, for example a silo belt 511. The silo belt 110 may transport the discharged proppant onto one or more conveyors 510. In other embodiments, silo 110 may comprise a discharge gate (not shown) underneath or at the bottom of a silo 110 covering a discharge opening of the silo 110. When the gate is closed, the discharge gate may secure proppant within the silo 110 and prevent any proppant from flowing out of the silo 110. When the discharge gate is opened, proppant may flow out of the discharge opening and onto a conveyor 510 located directly below the discharge opening (not shown). As would be understood by one of ordinary skill in the art, other configurations may be appropriate where the conveyor 510 is not located directly below the discharge opening but instead may be located adjacent to the discharge opening of a silo 110. A conveyor 510 may transport proppant from one location to another, for example, from a silo 110 to a blender or mixer (not shown).

In an embodiment of the present disclosure, a control unit (not shown) may be used to control a method for unloading proppant into a silo 110. The control unit may be communicatively coupled to any one or more of a transport vehicle 505, silo 110, well site 500, and conveyor 510. The control unit may further comprise an interface so that a human operator may monitor and control. The control unit may be operated by a human operator or may be automated according to a certain set of rules.

For example, in some embodiments, the control unit may be operable to query the proppant level via one or more sensors (not shown) of a silo 110. Upon the control unit detecting a proppant level below a threshold (which may be input by an operator), the control unit may send a signal to one or more transport vehicles 505 located at an unloading area 515 to begin pneumatically pumping to unload additional proppant into the one or more silos 110. Alternatively, one or more human operators may visually inspect when additional proppant should be unloaded into one or more silos 110. For example, a first operator may visually inspect the proppant levels of one or more silos 110 at an unloading area 515 to determine which specific silo 110, for example, silo 110a, is below a given threshold or otherwise needs additional proppant. Upon determining there is an insufficient amount of proppant in a given silo 110, a first operator may radio or contact a second operator or control unit at an unloading area to connect a transport vehicle 505 to silo 110a. The first operator may further radio or contact the second operator at a transport vehicle 505 and notify the second operator or control unit to cease unloading proppant once the proppant in silo 110a has reached a certain threshold.

Thus, the present disclosure provides an improved apparatus and system for transporting proppant from a transport truck to a storage container. The improved inlet provides more efficient unloading of proppant into a silo that reduces energy costs, health hazards resulting from dust emanation, and the amount of time personnel is needed to oversee proppant unloading operations, thus allowing personnel to devote time resources to other significant tasks. The improved inlet also reduces equipment costs and damage to particulate material compared to prior inlets and inlet systems. Rather than replace the entire inlet, only the diverter plate may be replaced due to the majority of the wear and tear being absorbed by the diverter plate alone.

1. An apparatus for receiving proppant into a storage container, comprising:
a housing that comprises:
a first planar surface having an outlet port; and
a second planar surface substantially perpendicular to the first planar surface, the second planar surface having a tubular slot formed therein; and
a diverter plate coupled to the housing and adjacent the outlet port, the diverter plate being oriented at an acute angle to the first planar surface of the housing.

2. The apparatus of claim 1, wherein the diverter plate is removable from the housing.

3. The apparatus of claim 1, wherein the housing is coupled to a fill tube via the tubular slot.

4. The apparatus of claim 1, wherein the outlet port of the housing is coupled to a filler opening of the storage container.

5. The apparatus of claim 1, wherein the diverter plate comprises a material thickness that is thicker than a material thickness of the housing.

6. The apparatus of claim 1, wherein the apparatus comprises a single impact point.

7. The apparatus of claim 1, wherein the diverter plate is oriented at an angle of 45 degrees from the first planar surface of the housing.

8. A system for transferring of proppant, comprising:
a storage container for storing proppant, wherein the storage container comprises a filler opening at or adjacent to a top of the storage container; and
an inlet apparatus, wherein the inlet apparatus is coupled to the storage container and wherein the inlet apparatus comprises:
a housing that comprises:
a first planar surface having an outlet port, wherein the outlet port is coupled to the filler opening of the storage container; and
a second planar surface substantially perpendicular to the first planar surface, the second planar surface having a tubular slot formed therein; and
a diverter plate coupled to the housing and adjacent the outlet port, the diverter plate being oriented at an acute angle to the first planar surface of the housing.

9. The system of claim 8, wherein the storage container is a silo.

10. The system of claim 9, further comprising:
a fill tube coupled to and positioned vertically along the silo, wherein the fill tube is further coupled to the inlet apparatus via the tubular slot.

11. The system of claim 10, wherein the fill tube is coupled to the inlet apparatus via one or more fasteners such that a seal is formed between the fill tube and the inlet apparatus.

12. The system of claim 10, wherein the fill tube is coupled to a transport vehicle via one or more flexible hoses.

13. The system of claim 8, wherein the diverter plate is removable from the housing.

14. The system of claim 8, further comprising:
a first inlet apparatus and a second inlet apparatus both coupled to the storage container.

15. A method for receiving proppant into a silo, comprising:
coupling an inlet apparatus to a filler opening at or adjacent to a top of the silo, wherein the inlet apparatus comprises:
a housing that comprises:
a first planar surface having an outlet port; and
a second planar surface substantially perpendicular to the first planar surface, the second planar surface having a tubular slot formed therein; and
a diverter plate coupled to the housing and adjacent the outlet port, the diverter plate being oriented at an acute angle to the first planar surface of the housing;
coupling the inlet to a fill tube positioned along the silo, wherein the fill tube is further coupled to a transport vehicle for unloading proppant; and
pneumatically pumping proppant from the transport vehicle through the inlet apparatus and into the silo.

16. The method of claim 15, further comprising:
removing the diverter plate from the inlet apparatus; and
coupling a new diverter plate to the inlet apparatus.

17. The method of claim 15, wherein coupling the inlet apparatus to the filler opening of the silo comprises welding the inlet apparatus to the silo.

18. The method of claim 15, wherein coupling the inlet apparatus to the fill tube comprises securing the inlet apparatus to the fill tube using one or more fasteners.

19. The method of claim 15, further comprising:
discharging proppant from the silo onto a conveyor; and
transporting proppant to a blender or mixer.

20. The method of claim 15, further comprising:
detecting a measured amount of proppant stored in the silo;
comparing the measured amount of proppant to a threshold; and
if the measured amount of proppant is less than the threshold, pneumatically pumping additional proppant from the transport vehicle through the inlet apparatus and into the silo.
